(19) United States
(12) Patent Application Publication
(10) Pub. No.: US 2023/0137205 A1
(43) Pub. Date: May 4, 2023

(54) TECHNIQUE FOR AUTONOMOUSLY MANAGING CACHE USING MACHINE LEARNING

(71) Applicant: Nvidia Corporation, Santa Clara, CA (US)

(72) Inventors: Yaosheng Fu, Santa Clara, CA (US); Shie Mannor, Santa Clara, CA (US); Evgeny Bolotin, Santa Clara, CA (US); David Nellans, Santa Clara, CA (US); Gal Dalal, Santa Clara, CA (US)

(21) Appl. No.: 17/514,735

(22) Filed: Oct. 29, 2021

(51) Int. Cl. G06F 12/123; G06N 20/00; G06T 1/60

(52) U.S. Cl. CPC G06F 12/123; G06N 20/00; G06T 1/60; G06T 1/20

(57) ABSTRACT

Introduced herein is a technique that uses ML to autonomously find a cache management policy that achieves an optimal execution of a given workload of an application. Leveraging ML such as reinforcement learning, the technique trains an agent in an ML environment over multiple episodes of a stabilization process. For each time step in these training episodes, the agent executes the application while making an incremental change to the current policy, i.e., cache-residency statuses of memory address space associated with the workload, until the application can be executed at a stable level. The stable level of execution, for example, can be indicated by performance variations, such as standard deviations, between a certain number of neighboring measurement periods remaining within a certain threshold. The agent, who has been trained in the training episodes, infers the final cache management policy during the final, inferring episode.

### TECHNICAL FIELD

This application is directed, in general, to machine learning (ML) and, more specifically, to using ML to manage on-chip cache capacity and allocation/eviction policy in software.

### BACKGROUND

Cache management is an important aspect in modern computing systems because a well-managed cache can effectively reduce off-chip memory access and related power consumption and significantly improve overall system performance. Cache has been managed mainly through hardware, and prior efforts on improving cache management have been limited to improving hardware implementation.

### SUMMARY

In one aspect, the disclosure provides a method of managing a cache located on a processor of a computing system. In one example, the method includes: training a machine learning (ML)agent to autonomously learn a cache management policy of the cache for executing a particular application on the computing system, wherein locations in a memory address space is associated with a workload of the particular application, and said training includes using the agent to continuously make an incremental change to current cache-residency statuses of the locations until the particular application is executed at a stable level; and deploying the policy to manage the cache.

In another aspect, the disclosure provides a computer program product having a series of operating instructions stored on a non-transitory computer-readable medium that directs a processor of a computing system when executed thereby to perform operations. In one example, the operations includes: training a machine learning (ML) agent to autonomously learn a cache management policy of a cache located on the processor for executing a particular application on the computing system, wherein locations in a memory address space is associated with a workload of the particular application, and said training includes using the agent to continuously make an incremental change to current cache-residency statuses of the locations until the particular application is executed at a stable level; and deploying the policy to manage a cache located on the processor.

In yet another aspect, the disclosure provides a computing system. In one example, the computing system includes: a processor having a cache located thereon, wherein the processor trains a machine learning (ML) agent to autonomously learn a cache management policy of the cache for executing a particular application on the computing system, and locations in a memory address space is associated with a workload of the particular application; and wherein the agent is trained to autonomously learn the cache management policy by continuously making an incremental change to current cache-residency statuses of the locations until the particular application is executed at a stable level.

In yet still another aspect, the disclosure provides a method of managing a cache located on a processor of a computing system. In one example, the method includes: executing an application on the processor, the application having a workload which utilizes a memory address space; and during said executing, allowing a machine learning agent to autonomously learn a cache management policy for the cache by repeatedly making incremental changes to current cache-residency statuses of locations in the memory address space.

### BRIEF DESCRIPTION

Reference is now made to the following descriptions taken in conjunction with the accompanying drawings, in which:

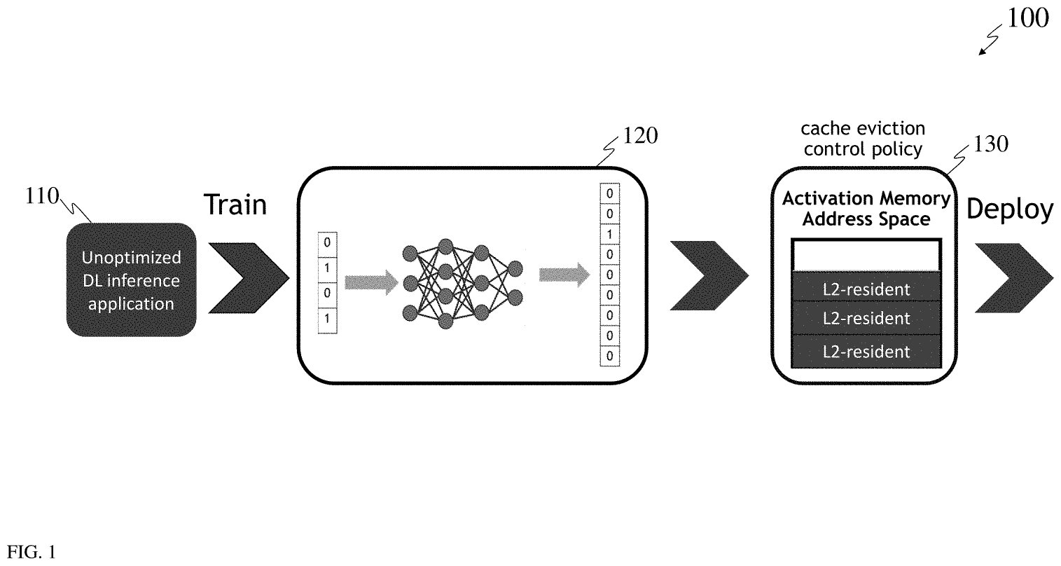

FIG. 1 illustrates a diagram of an embodiment of a cache residency management technique according to the principles of the disclosure;

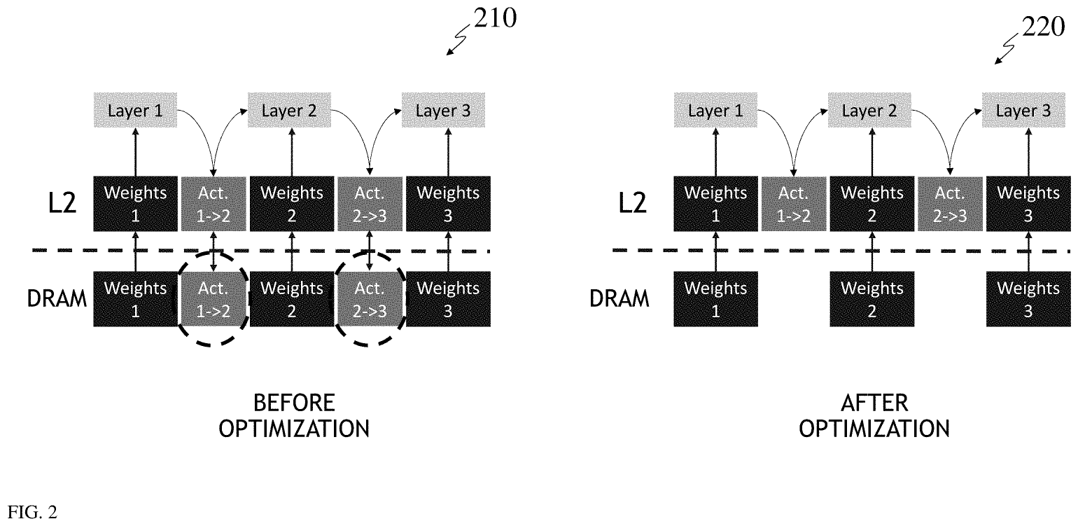

FIG. 2 illustrates an exemplary DL application execution before and after the cache residency management technique has been applied;

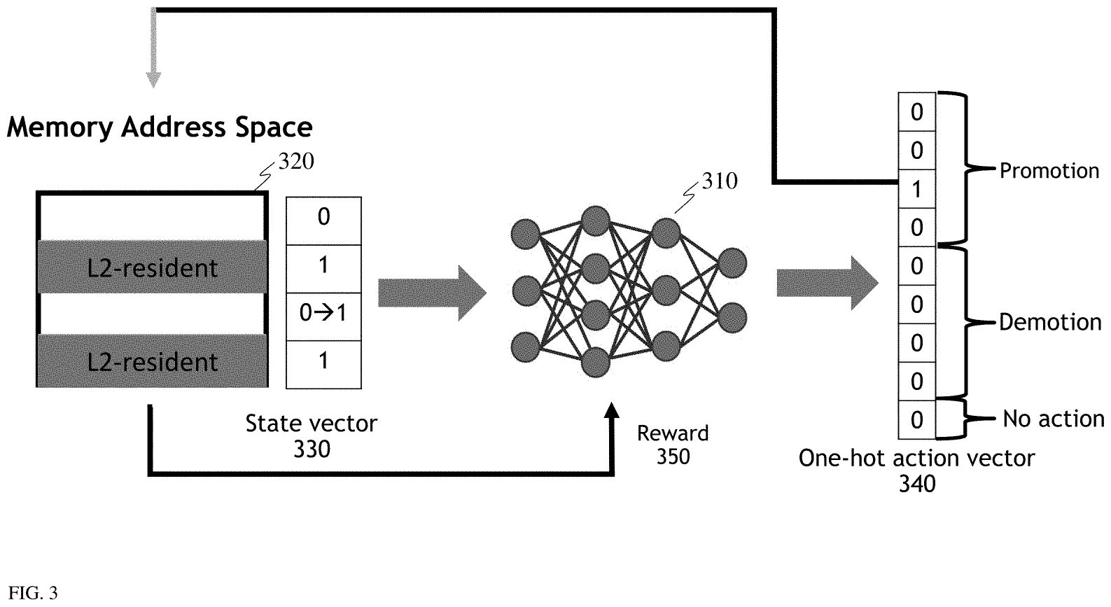

FIG. 3 illustrates a diagram of an embodiment of ML utilized in finding an optimal cache management policy;

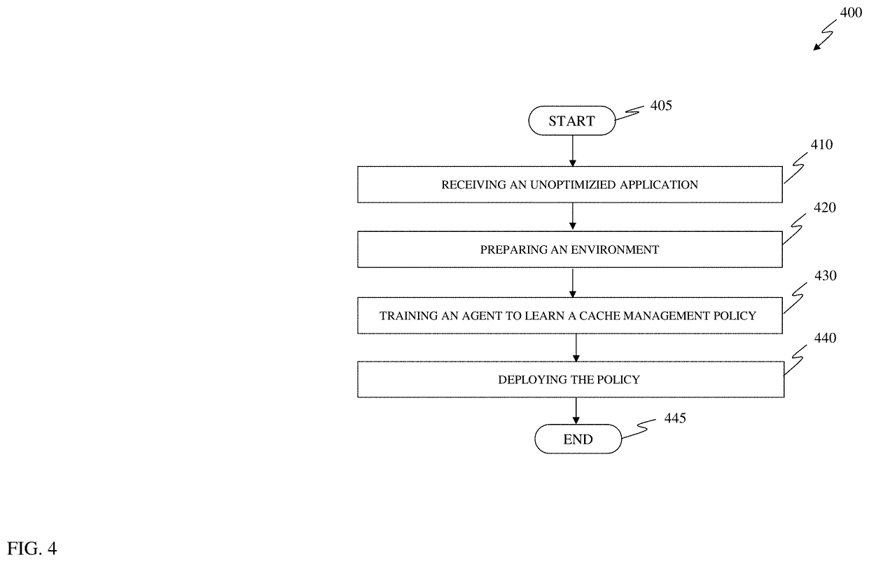

FIG. 4 illustrates a flow diagram of an embodiment of a method for managing a cache;

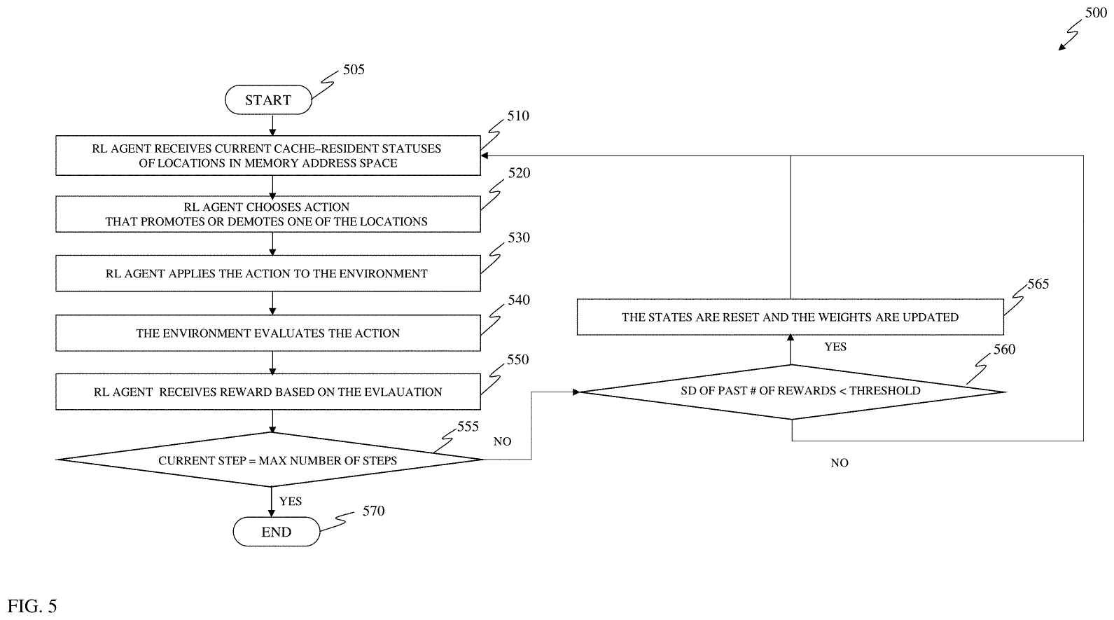

FIG. 5 illustrates a flow diagram of an embodiment of a method for training an RL agent to autonomously learn an optimal cache management policy; and

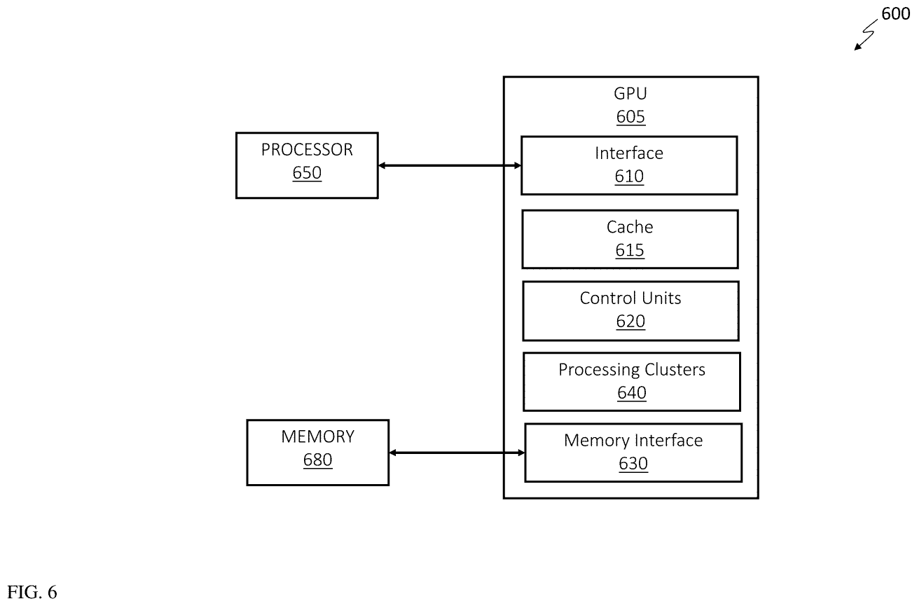

FIG. 6 illustrates a block diagram of an example of a computing system in which at least a portion of the disclosed systems, methods, or apparatuses can be implemented.

### DETAILED DESCRIPTION

One of the main limitations of hardware implementation has been its limited visibility of the cache management software. The hardware implementation did not allow direct access to program level semantics of cache management software and has prevented programmers from considering global state and prior and future re-use patterns of cache. As a result, the programmers have been limited to making localized decisions making minimal impact to the actual cache management process.

Introduced herein is a technique that addresses the limitations of hardware implementation by utilizing a new hardware feature called cache eviction control. This feature has been recently introduced in a new GPU architecture, such as in Ampere architecture from NVIDIA Corporation of Santa Clara, Calif. Unlike hardware implementation, the cache eviction control allows programmers to explicitly control the cache management process via a software application programming interface (API). The technique allows programmer to manage a previously hardware managed cache using software.

Using the new feature, the introduced technique allows direct access to program-allocated memory, which can be promoted and demoted within a cache at different granularities, and provides more headroom for improved optimization and performance. With increased headroom, the introduced technique allows programmers to implement much more complex intelligence to find a cache management policy, which achieves more predictable cache behaviors, improved performance, and increased energy efficiency.

Using this new feature, however, can be difficult to reason about and implement because it requires non-negligible programming efforts from an expert programmer. The required programming includes an exhaustive search on the memory address space. As the space grows exponentially with the increasing cache capacity and memory footprint, so does the amount of the searching efforts. The programmer also must have detailed knowledge about GPU architecture and cache configuration and be able to make complex decisions using the knowledge. Choosing the right buffers, sizes, and when to transition between active and inactive buffers is an example of complex decision making that requires detailed knowledge of what is currently in the cache and how to extrapolate the future re-use of the data and new data in future computational phases.

The introduced technique removes the need for these expert programming efforts using ML to autonomously find a cache management policy that achieves an optimal execution of a given workload of an application. The introduced technique also obviates the need for detailed knowledge of the GPU microarchitecture and cache configuration. With the transparency and accessibility of data in a cache afforded by the new cache eviction control API, the technique can readily prioritize any data in a cache or scratchpad to arrive at an optimal cache management policy without changing the program semantics.

Moreover, since the introduced technique may be performed on a per-workload basis, it can tailor and optimize each policy to each different workload and can significantly increase cache hit rate and reduce memory traffic compared to using a general policy. The increased hit rate and reduced memory traffic will, potentially unlock unrealized performance that has been bottled necked by inefficient cache management. Furthermore, as the introduced technique reduces off-chip data access and related power consumption, it would improve overall energy efficiency of the system, and free programmers from heuristics-based manual tuning efforts, which may take up weeks and cannot achieve a sufficient level of optimization.

Due to the repetitive nature, the introduced technique may be best utilized in optimizing deep learning applications. The technique, however, is not limited to such applications and would be a good fit for any applications with repetitive tasks occurring at the programmatic level, such as high-performance computing (HPC) applications.

Leveraging ML such as reinforcement learning, the introduced technique trains an agent in an ML environment over multiple episodes of a stabilization process. During these training episodes, the agent executes the application while continuously/repeatedly, i.e., for each time step in the episodes, making an incremental change to the current policy, i.e., cache-residency statuses of memory address space associated with the workload, until the application can be executed at a stable level. The stable level of execution, for example, can be indicated by performance variance, such as a standard deviation, between a certain number of neighboring measurement periods remaining within a certain threshold. The agent, who has been trained in the multiple training episodes, infers the final cache management policy during the final, inferring episode.

The term “optimal execution” used in the disclosure refers to an execution of an application that achieves the best performance at the stable level under a given time period, e.g., a number of time steps. The performance can be measured and quantified, for example, in an execution time, an amount of off-chip memory traffic, a performance per watt or any combination thereof. It is understood that the terms, such as “optimal,” “optimization” and “optimum,” used in the disclosure refer to a condition or a status that achieves the best performance at the stable level under a given time period.

FIG. 1 illustrates a diagram of an embodiment of a cache residency management technique 100 according to the principles of the disclosure. The technique 100 is a ML based technique that leverages ML 120 to determine a cache management policy 130 that can achieve an optimal execution of a given application 110. It is understood that the term “cache” in the disclosure refers to an on-chip memory, such as L1 or L2 cache or a scratchpad memory that is located on a same chip as a corresponding processing unit.

In the illustrated embodiment, the application 110 is an unoptimized deep learning (DL) inference application and the type of ML 120 used is a reinforcement learning (RL). An RL agent trains through interactions with an RL environment of the application 110 and learns a cache management policy 130 that can achieve an optimal execution of the application 110. The policy 130 represents a set of locations in memory address space, e.g., ranges of virtual memory for the workload of the application 110, that that should be cache-resident for an optimal execution of the application 110. The learned policy is deployed to manage a cache. Both the agent training and the policy deployment are performed using an API.

FIG. 2 illustrates an example of a DL application execution before 210 and after 220 the cache residency optimization, i.e., a deployment of an optimal cache management policy. At runtime, activations are generated from a previous layer to a next layer. Before the optimization 210, both weights of the layers and the activations between the layers of the DL application are written to and read from a DRAM through a L2 cache during the application execution. But after the optimization 220, only the weights are written to and read from the DRAM through the L2 cache, and all of the activations are directly written to and read from the L2 cache during the execution.

The amount of the activations that can be written to and read directly from the L2 cache depends on the capacity of the L2 cache. In the illustrated embodiment, the capacity of the L2 cache is big enough to store all the activations and as described above, all the activations are written to and read directly from the L2 cache during the execution. Although not illustrated, when the capacity of the L2 cache permits, some of the weights can also be written to and read directly from the L2 cache.

FIG. 3 illustrates a diagram of an embodiment of a neural network (NN) 310 utilized in finding an optimal cache eviction policy. In the illustrated embodiment, the NN 310 represents an RL agent 310, which is a feedforward network such as a multi-layer perceptron (MLP) network with two hidden layers, and an RL environment 320, which is a DL training or inference application with the cache eviction control API. It is understood that the type of NN that can be used is not limited to a feedforward network and includes other NNs such as a regulatory feedback network, a radial basis function network, a recurrent NN, and a modular network.

In the illustrated embodiment, the agent 310 makes an observation of the environment 320 and receives a state 330, which is a current cache-residency statuses of locations in the memory address space, i.e., a current cache-residency statuses of address ranges in a virtual memory that is associated with workload of the application. The state is represented by an N-dimensional binary vector and each single bit represents whether the corresponding location in the memory address space is a cache resident, i.e., “1”, or a non-resident, i.e., “0.” In the illustrated embodiment, N is 4, and the second and fourth locations of the memory address space are currently indicated to be cache-residents.

Based on the state 330, the agent 310 chooses and applies an action 340 to the environment 320. The action 340 can promote one of the locations in the memory address space to a cache-resident, demote it to non-cache resident or perform “no action.” The action 340 is a 2N+1 dimensional one-hot vector, and each single bit represents whether the corresponding location in the memory address space should be promoted, demoted, or left as it is. The first, i.e., the top, N digits are used for promotion, the next N digits are used for demotion and the last digit is used to indicate “no action.” In the illustrated embodiment, the third digit from the top is set as “1”, which indicates promoting the third location in the memory address space to a cache-resident.

After the action 340 is applied, the application is executed. The execution time is quantified as an execution metric and provided to the agent as a reward 350. In the illustrated embodiment, the reward is defined as a difference in the execution time between consecutive states. The reward is defined so that the agent's motivation to accumulate the highest possible reward coincides with finding a state that yields the lowest execution time.

It is understood that the reward is not limited to the execution time. In some embodiments, the reward 350 may include an amount of traffic, e.g., a number of accesses, to DRAM occurred while executing the application and/or a performance per watt of a computing system executing the application.

The above-mentioned interactions between the agent 310 and the environment 320 occur during one time step and are repeated in each additional time step until the reward indicates that the execution has reached a stable level. The term “stable” refers to the performance variations between neighboring steps being within a certain threshold. For example, when a standard deviation between a predefined number of past rewards, such as last 50 rewards, becomes less than a predefined threshold, it can be inferred that the stable level has been reached.

FIG. 4 illustrates a flow diagram of an embodiment of a method 400 for managing a cache. The method 400 may be performed using ML. In the illustrated embodiment, the method 400 utilizes RL that includes a RL agent in an RL environment. The agent represents a NN such as a multi-layer perceptron (MLP) network with two hidden layers. The method 400 starts at step 405.

At step 410, an application to be optimized is received by a computing system. In the illustrated method 400, the received application is a DL application for training or inferencing with the cache eviction control API. The application needs an optimization, i.e., a better cache management policy, so that when executed, it can access the maximum number of its activation functions and even some weights from an on-chip cache, instead of an off-chip memory such as a DRAM. It is understood that while the application to be optimized is not limited to a DL application, any application that performs parallel processing, e.g., repetitive and contemporaneous calculations and data access, such as an HPC application, would be a good fit for the optimization.

At step 420, the RL environment in which the agent will be trained is prepared. During the step 420a, a memory address space, which stores virtual memory address ranges of the workload for the application, is divided into locations or bins, and a single bit “0” or “1” is assigned to each location. “0” indicates that the corresponding location is a non-cache resident and “1” indicates that the corresponding location is a cache-resident. As the baseline to learn from, all of the single digits are set to “0.”

At step 430, the agent is trained to learn a cache management policy. The training is carried out over multiple episodes, each of which comprises a plurality (thousands if not millions) of time steps/periods. After each episode, the weights of the agent are adjusted, and the states are reset. The step 430 continues until it reaches the maximum number of the time steps, and the cache-residency statuses of locations in the memory address space at such time represents a cache eviction policy that allows an optimal execution of the application. The step 430 is discussed in more detail below with FIG. 5.

It is understood that step 430 can be online, offline, or even a combination of both online and offline. “Offline learning/training” is carried out using a generic application/workload before an application to be optimized and the learned cache eviction policy is deployed by production. This variant can work best when the learned policy is unlikely to change per application/workload. One of the examples of this “offline learning/training” is training an agent for DL inference application, where a developer will choose to optimize the software API usage of a cache/scratchpad as part of a tuning process per network and per GPU (with different performance and cache characteristics). This learned policy is then pre-packaged with the inference network implementation to optimize performance on the same system where it runs in the future. Such an offline optimization can be a part of a software development kit (SDK), such as NVIDIA TensorRT, to facilitate high-performance inference on processors such as a GPU and a hardware accelerator.

“Online learning” or training is a second training variant of the agent that occurs as a particular application is executing on a computing system. In online training, the agent is trained dynamically as the application executing on the computing system is evolving. For example, DL training is a very repeatable task, with millions of iterations performing the same sequence of computing layers as network weights and parameters are refined during the training process. In this case, the ML agent is actively learning and modifying the cache control operations while the training is being executed and dynamically deployed (refined) as RL framework is learning the best possible configuration.

Online learning can be further sub-categorized into the different categories, such as, single learner-multiple followers, multiple learners-multiple followers, and self-learner. For single learner multiple followers, one learner is learning and constantly refining the settings for the follower instances. In multi-processor training runs, such as GPU training runs, this would allow the training system to reduce its performance overhead of running on all agents and instead only execute on a single processor, with the learned policies being distributed out to other processors (e.g., GPUs) in the system.

For multiple learners-multiple followers, multiple ML agents in multi-GPU training situations could learn concurrently with different initial points in the search space for a reduced discovery time of near-optimal solutions. The best solutions can periodically be broadcast out to one or more of the follower processors for improved execution time.

With self-learner, the learning is performed using the first M iterations and learned function is deployed for the remaining N iterations (of a total M+N DL iterations) to reduce the performance impact of learning and running the agent on a single processor. This can also be combined with both of the prior online learning/following combinations.

At step 440, the learned cache eviction policy is deployed to a computing system on which the application is going to be executed. The policy may be deployed using an application programming interface (API) such as the cache eviction control API or as part of a software development kit (SDK) such as NVIDIA's TensorRT. The method 400 ends at step 445.

FIG. 5 illustrates a flow diagram of an embodiment of a method 500 for training an RL agent to autonomously learn a cache eviction policy that can achieve an optimal execution of a particular application. The method 500 corresponds to step 430 in FIG. 4 and illustrated from the RL agent's point of view. The agent may be a MLP with two hidden layers, and the particular application may be a DL application for inferencing. The method starts at step 505.

At step 510, for a current time step, the RL agent observes and receives a current state of the RL environment it is in. The RL environment corresponds to the cache residency control environment of the DL application with the cache eviction control API, and the current state corresponds to current cache-residency statuses of locations in the memory address space. The memory address space represents address ranges in a virtual memory that that is associated with the workload of the DL application.

At step 520, for the current time step, the RL agent choses an action based on the state received at step 510 and the agent's (NN's) weights. The reward is used to modify the weights such that the agent/NN can maximize reward over time.

At step 530, for the current time step, the RL agent applies the action to the RL environment by changing the current state of the environment. The action represents an incremental change to the current state. As shown in FIG. 3, the action corresponds to a one-hot action vector that includes a promotion of one of the locations to cache resident from non-cache resident, a demotion of one of locations to the non-resident cache resident from the cache-resident, or a no action.

At step 540, for the current time step, the environment evaluates the action by executing the particular application with the changed state. The execution in this step is very short (usually a few milliseconds) and usually executes or profiles only on the repetitive part of the particular application, which is the main body of the particular application.

At step 550, for the current time step, the RL agent receives a reward based on the evaluation of step 540. The reward may be an execution metric that varies based on how well, e.g., how fast, or efficiently, the particular application was executed in step 540. For example, the reward may vary based on an execution time of the application, an amount of traffic to DRAM occurred while executing the application or a performance per watt of the computing system executing the particular application.

At step 555, the RL agent determines whether a cache management policy that can achieve an optimal execution of the particular application has been found. The RL agent determines this by comparing the current number of the time step to the predefined maximum number of steps.

If the current number has not reached the maximum number, the RL agent determines whether the execution of step 540 has reached a stable level at step 560. As mentioned above, it can be inferred that the stable level has been reached when a standard deviation between a predefined number of past rewards becomes less than a predefined threshold. For example, the performance metric of concern may be an execution time, and the predefined number of past rewards may be 50, and the standard deviation may be 0.5.

If the stable level has been reached, the method 500 moves to step 565 where the current episode concludes. At step 565, the states are reset and the weights of the RL agent are updated for a new episode. The method 500 loops back to step 510 where the steps 510-555 are repeated for time steps in a new episode. If the stable level has not been reached, the method 500 loops back to step 510 where the step 510-550 are repeated for a subsequent time step of the current episode.

Returning back to step 555, by determining that the current time step has reached the maximum number, the RL agent also determines that a cache management policy achieving an optimal execution of the particular application has been found. Cache-residency statuses of locations in the memory address space at this time represents a cache management policy that allows an optimal execution of the particular application.

It is understood that various thresholds, such as the performance metric of interest, the number of past rewards to be considered, the standard deviation, and the maximum number of steps, are predefined before the method 500 begins. They are selected based on various factors, e.g., data from previous trainings of similar application, to warrant that the performance metric meets the required level of performance.

Once the optimal cache management policy has been found, the method 500 moves to step 570, where the method 500 ends.

FIG. 6 illustrates a block diagram of an example of a computing system 600 in which at least a portion of the disclosed systems, methods, or apparatuses can be implemented. The computing system 600 provides an example of a hardware accelerator, a GPU 605, included in the system 600 with one or more other devices. The computing system 600 can be embodied on a single semiconductor substrate and can include other devices such as additional GPUs. The GPU 605 can be coupled to the additional GPUs via one or more interconnects, such as high-speed interconnects. GPU 605 can be coupled to a processor 650 and a memory 680. The processor 650 can be another GPU or a host processor such as a CPU. The memory 680 can include multiple memory devices.

The computing system 600, or at least a portion of the computing system, can be on a cloud computing platform. For example, the GPU 605, the processor 650, the memory 680, or a combination of two or more can be on a server located in a cloud computing environment, such as in a data center. The data center can be a GPU data center. One or more of the GPU 605, the processor 650, and the memory 680 can also be distributed on different computing devices and the computing devices can be distal from one another. For example, the processor 650 and memory 680 can be located on one computing device or system and the GPU 605 can be located on another computing device or system.

The GPU 605 includes an interface 610, an on-chip cache 615, control units 620, a memory interface 630, and processing cluster 640. The GPU 605 can include additional components that are not illustrated but typically included in a GPU, such as communication busses and interconnects.

Interface 610 is an input and output interface configured to communicate data, commands, and other information, with external components, such as the processor 650. Interface 610 can transmit and receive data and commands over conventional interconnects. Received communications can be sent to the various components of the GPU 605, such as the control units 620. The cache 615 is an on-chip cache that located on a same chip as the GPU 605, and includes multiple cache levels (L1), L2, often L3 and rarely even L4) and a scratchpad memory. Management of data allocations in the cache 615 is optimized using an API, such as the cache eviction control API.

The control units 620 are configured to manage processing streams, configure the processing cluster 640 for processing tasks defined by the streams, distribute the tasks to processing cluster 640, and manage the execution of the tasks on the processing cluster 640. The results generated by the tasks can be directed to the memory interface 630. The memory interface 630 is configured to store the results in a memory, such as the memory 680. In addition to writing to the memory 680, the memory interface 630 is also configured to read data from the memory 680. The memory 680 can also store software or code corresponding to algorithms used by the disclosed systems, methods, or apparatuses. The code may include a series operating instruction that can direct operations of the processing clusters 640. The memory 680 can be or include a non-transitory computer readable medium.

The processing cluster 640 includes multiple processing cores for processing the tasks. The processing cores can be optimized for matrix math operations and can be employed for training NNs, such as training a RL agent as disclosed herein. The processing cluster 640 can include a pipeline manager that directs the operation of the processing cores for parallel processing of the tasks. The processing cluster 640 can also include additional components for processing the tasks, such as a memory management unit.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media or non-transitory computer-readable medium, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

The digital data processors or computers can be comprised of one or more processing units or processors. The processing unit may include one or more hardware accelerator such as GPUs, a deep learning accelerator, a vision processing unit, and a tensor processing unit, one or more CPUs, one or more of other processor types, or a combination thereof. The digital data processors and computers can be located proximate each other, proximate a user, in a cloud environment, a data center, or located in a combination thereof. For example, some components can be located proximate the user and some components can be located in a cloud environment or data center.

The processing units in the processors or computers, such as GPUs, can be embodied on a single semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on a single chip. Configured or configured to means, for example, designed, constructed, or programmed, with the necessary logic and/or features for performing a task or tasks.

The processors or computers can be part of GPU racks located in a data center. The GPU racks can be high-density (HD) GPU racks that include high performance GPU compute nodes and storage nodes. The high-performance GPU compute nodes can be servers designed for general-purpose computing on graphics processing units (GPGPU) to accelerate deep learning applications. For example, the GPU compute nodes can be servers of the DGX product line from Nvidia Corporation of Santa Clara, Calif.

The compute density provided by the HD GPU racks is advantageous for artificial intelligence (AI) computing and GPU data centers directed to AI computing. The HD GPU racks can be used with reactive machines, autonomous machines, self-aware machines, and self-learning machines that all require a massive compute intensive server infrastructure. For example, the GPU data centers employing HD GPU racks can provide the storage and networking needed to support large-scale deep NN training, such as for the NNs disclosed herein that are used for routing nets.

The NNs disclosed herein include multiple layers of connected nodes that can be trained with input data to solve complex problems. For example, the input images can be game images used as input data for constructing, training, and employing a routing model for an RL agent. Once the NNs are trained, the NNs can be deployed and used to identify and classify objects or patterns in an inference process through which a NN extracts useful information from a given input. For example, the NNs can be used to determine connections between terminals groups of the nets of circuits.

During training, data flows through the NNs in a forward propagation phase until a prediction is produced that indicates a label corresponding to the input. When the NNs do not correctly label the input, errors between the correct label and the predicted label are analyzed, and the weights are adjusted for features of the layers during a backward propagation phase that correctly labels the inputs in a training dataset. With thousands of processing cores that are optimized for matrix math operations, GPUs such as noted above are capable of delivering the performance required for training NNs for artificial intelligence and machine learning applications.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Each of the aspects disclosed in the Summary may have one or more of the additional features of the dependent claims in combination. It is noted that as used herein and in the appended claims, the singular forms “a”, “an”, and “the” include plural referents unless the context clearly dictates otherwise.

What is claimed is:

1. A method of managing a cache located on a processor of a computing system, comprising:
training a machine learning (ML) agent to autonomously learn a cache management policy of the cache for executing a particular application on the computing system, wherein locations in a memory address space is associated with a workload of the particular application, and said training includes using the agent to continuously make an incremental change to current cache-residency statuses of the locations until the particular application is executed at a stable level; and
deploying the policy to manage the cache.

2. The method of claim 1, wherein the agent is implemented as a multi-layer perceptron (MLP) network with two hidden layers.

3. The method of claim 1, wherein said training and said deploying are performed using an application programming interface.

4. The method of claim 1, wherein said training is performed before executing the particular application.

5. The method of claim 1, wherein said training is performed while executing the particular application.

6. The method of claim 5, wherein said training is performed by the processor and said deploying is performed by other processors in the computing system.

7. The method of claim 5, wherein said training is performed using multiple processors in the computing system including the processor, and said deploying is performed by the multiple processors.

8. The method of claim 5, wherein said training and said deploying are performed by the processor.

9. The method of claim 1, wherein the ML agent is a reinforcement learning (RL) agent in an RL environment.

10. The method of claim 1, wherein the particular application is a deep learning (DL) application for training or inferencing, and the locations in the memory address space represent virtual address ranges for the workload.

11. The method of claim 10, wherein some of the locations that are associated activation data of the DL application.

12. The method of claim 10, wherein some of the locations are associated with weight data of the DL application.

13. The method of claim 1, wherein the processor is a graphics processing unit (GPU).

14. The method of claim 1, further comprising:
before said training, preparing an ML environment for the agent by dividing the memory address space into the locations, each location being represented by a single bit that indicates a cache-residency status of a corresponding location, and setting each single bit to zero.

15. The method of claim 14, wherein said training includes receiving from the ML environment a state that corresponds to the current cache-residency statuses of the locations.

16. The method of claim 15, wherein the state is represented by an N-dimensional binary vector.

17. The method of claim 15, wherein said training includes choosing an action that corresponds to the incremental change based on the state.

18. The method of claim 17, wherein the action corresponds to a promotion of one of the locations to a cache resident, a demotion of the one location to a non-cache cache resident or a no-action.

19. The method of claim 18, wherein the action is represented by a 2N+1 dimensional one-hot vector.

20. The method of claim 1, wherein said training includes receiving a reward that corresponds to an execution metric indicating whether the stable level has been achieved.

21. The method of claim 20, wherein the execution metric corresponds to an execution time of the particular application on the computing system, an amount of traffic to a DRAM while executing the particular application on the computing system or a performance per watt of the computing system executing the particular application.

22. The method of claim 1, further comprising learning the cache management policy using the trained agent, wherein the current cache-residency statuses of the locations become final cache-residency statuses of the location when predefined time for said training and said learning runs out.

23. The method of claim 1, wherein said training includes determining that the stable level has been achieved when a standard deviation between a predefined number of past rewards is less than a predefined threshold.

24. A computer program product having a series of operating instructions stored on a non-transitory computer-readable medium that directs a processor of a computing system when executed thereby to perform operations comprising:
training a machine learning (ML) agent to autonomously learn a cache management policy of a cache located on the processor for executing a particular application on the computing system, wherein locations in a memory address space is associated with a workload of the particular application, and said training includes using the agent to continuously make an incremental change to current cache-residency statuses of the locations until the particular application is executed at a stable level; and
deploying the policy to manage a cache located on the processor.

25. A computing system comprising:
a processor having a cache located thereon, wherein the processor trains a machine learning (ML) agent to autonomously learn a cache management policy of the cache for executing a particular application on the computing system, and locations in a memory address space is associated with a workload of the particular application; and
wherein the agent is trained to autonomously learn the cache management policy by continuously making an incremental change to current cache-residency statuses of the locations until the particular application is executed at a stable level.

26. The system of claim 25, wherein the incremental change corresponds to an action, and the current cache-residency statuses correspond to a state of an ML environment that the agent is in.

27. The system of claim 26, wherein the state is represented by an N-dimensional binary vector.

28. The system of claim 26, wherein the action corresponds to a promotion of one of the locations to a cache resident, a demotion of the one location to a non-cache resident or a no-action.

29. The system of claim 26, wherein the action is represented by a 2N+1 dimensional one-hot vector.

30. The system of claim 25, wherein the agent receives a reward that corresponds to an execution metric indicating whether the stable level has been achieved.

31. The system of claim 30, wherein the execution metric corresponds to an execution time of the particular application on the computing system, an amount of traffic to a DRAM while executing the particular application on the computing system or a performance per watt of the computing system executing the particular application.

32. The system of claim 25, wherein the trained agent learns the cache management policy, wherein the current cache-residency statuses of the locations become final cache-residency statuses of the location when predefined time for said training and said learning runs out.

33. The system of claim 25, wherein the agent determines that the stable level has been achieved when a standard deviation between a predefined number of past rewards is less than a predefined threshold.

34. The system of claim 25, wherein the processor deploys the policy using an application programming interface.

35. The system of claim 25, wherein the agent is trained using an application programming interface.

36. The system of claim 25, wherein the agent is a multi-layer perceptron (MLP) network with two hidden layers.

37. The system of claim 25, wherein the agent is a reinforcement learning (RL) agent in an RL environment.

38. The system of claim 25, wherein the particular application is a deep learning (DL) application for training or inferencing, and the locations in the memory address space represent virtual address ranges for the workload.

39. The system of claim 38, wherein some of the locations are associated with activation data of the DL application.

40. The system of claim 38, wherein some of the locations are associated with weight data of the DL application.

41. The system of claim 25, wherein the particular application is a high-performance computing (HPC) application.

42. The system of claim 25, wherein the agent is trained to learn the cache management policy before an execution of the particular application.

43. The system of claim 25, wherein the processor is a GPU.

44. The system of claim 25, wherein the computing system is one of DL computing systems located in a data center.

45. A method of managing a cache located on a processor of a computing system, comprising:
executing an application on the processor, the application having a workload which utilizes a memory address space; and
during said executing, allowing a machine learning agent to autonomously learn a cache management policy for the cache by repeatedly making incremental changes to current cache-residency statuses of locations in the memory address space.

46. The method of claim 45, wherein the incremental changes are repeatedly made until the application is executed at a stable level.

47. The method of claim 46, wherein the stable level has been achieved when a standard deviation between a predefined number of past rewards is less than a predefined threshold.

48. The method of claim 45, wherein the agent is a reinforcement learning (RL) agent in an RL environment.

49. The method of claim 45, wherein the application is a deep learning (DL) application for training or inferencing, and the locations in the memory address space represent virtual address ranges for the workload.

50. The method of claim 45, wherein some of the locations that are associated activation data of the DL application.
